(19) United States
(12) Patent Application Publication
(10) Pub. No.: US 2024/0142687 A1
(43) Pub. Date: May 2, 2024

(54) LIGHT-EMITTING ARRAY WITH REFLECTIVE POLARIZER FOR PHOTON RECYCLING

(71) Applicant: Meta Platforms Technologies, LLC, Menlo Park, CA (US)

(72) Inventors: Liliana Ruiz Diaz, Bothell, WA (US); Sheng Ye, Redmond, WA (US); Zhaoyu Nie, Kenmore, WA (US); Tanya Malhotra, Frederick, MD (US); Christopher Yuan Ting Liao, Seattle, WA (US); Ehsan Vadiee, Bothell, WA (US); Andrew John Ouderkirk, Kirkland, WA (US)

(21) Appl. No.: 18/495,922

(22) Filed: Oct. 27, 2023

Related U.S. Application Data
(60) Provisional application No. 63/381,555, filed on Oct. 29, 2022.

(51) Int. Cl. G02B 5/30; G02B 27/01

(52) U.S. Cl. CPC G02B 5/305; G02B 5/3083; G02B 27/0172

(57) ABSTRACT

A lighting assembly may include a light source and a reflective polarizer overlapping the light source. A portion of light that is incident on the reflective polarizer may not pass through the reflective polarizer and may be reflected back to the light source. The light source may include at least one of a light emitting diode (LED), a micro-LED, an organic light emitting diode (OLED), a micro-OLED, a liquid crystal on silicon (LCoS), or an fLCoS light source. The reflective polarizer may include a polymer birefringent multilayer structure of alternating first layers and second layers. The first layers may each include an isotropic polymer thin film the second layers each include an anisotropic polymer thin film. Various other devices, systems, and methods are also disclosed.

This application claims the benefit of U.S. Provisional Application No. 63/381,555, filed Oct. 29, 2022, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. 1A-1B are schematic illustrations of an example system that includes a thin reflective polarizer overlapping a light-emitting array according to some embodiments.

FIGS. 2A-2C are top and side views of example light-emitting assemblies having reflective polarizers overlapping light-emitting diodes (LEDs) according to some embodiments.

FIG. 3 is a schematic illustration of an example system that includes thin reflective polarizers overlapping a light-emitting array according to some embodiments.

FIGS. 4A-4B are illustrations of polarized light emitted from light-emitting assemblies according to some embodiments.

FIG. 5A-5C are cross-sectional views of conformal reflective polarizer films overlapping various LED surfaces according to some embodiments.

FIG. 6A is a diagram illustrating an example light-emitting assembly and spectrums of polarized light emitted from the assembly according to some embodiments.

FIG. 6B is a chart illustrating spectrums of polarized light emitted from an example light-emitting assembly according to some embodiments.

FIG. 6C is a chart illustrating polarized light passing through an example reflective polarizer according to some embodiments.

FIG. 7A is a diagram illustrating p-polarized light reflection characteristics for an example broadband reflective polarizer design for use with multicolor light-emitting assemblies according to some embodiments.

FIG. 7B is a diagram illustrating thicknesses of layers in the example broadband reflective polarizer design of FIG. 7A.

FIG. 7C is a diagram illustrating p-polarized light reflection characteristics for an example broadband reflective polarizer design for use with multicolor light-emitting assemblies according to some embodiments.

FIG. 7D is a diagram illustrating thicknesses of layers in the example broadband reflective polarizer design of FIG. 7C.

FIG. 8A shows a cross-sectional view of an example liquid crystal device that includes a reflective polarizer according to some embodiments.

FIG. 8B shows a cross-sectional view of an example reflective polarizer that is disposed between two peelable skin layers according to some embodiments.

FIG. 9A shows a cross-sectional view of a reflective polarizer stack having two reflective polarizer layers disposed between a pair of peelable skin layers according to some embodiments.

FIG. 9B shows a cross-sectional view of the example reflective polarizer stack of FIG. 9A overlapping a micro-LED array according to some embodiments.

FIG. 10A shows a cross-sectional view of an example conformable reflective polarizer overlapping a micro-LED array according to some embodiments.

FIG. 10B shows a cross-sectional view of an example conformable reflective polarizer overlapping a micro-LED array according to some embodiments.

FIG. 10C shows a cross-sectional view of an example conformable reflective polarizer overlapping a micro-LED array with fill resin disposed between raised regions of the array according to some embodiments.

FIG. 11 is a flow diagram of an exemplary method for forming a reflective polarizer assembly according to some embodiments.

FIG. 12 is an illustration of exemplary augmented-reality glasses that may be used in connection with embodiments of this disclosure.

FIG. 13 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Artificial reality devices, such as virtual reality (VR) and augmented reality (AR) eyewear devices or headsets, may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. Governments may use such devices for military training, medical professionals may use such devices to simulate surgery, and engineers may use such devices as design visualization aids.

These and other applications may leverage one or more characteristics of polymer and/or other tailored materials to improve optical and structural characteristics in beneficial ways. For example, refractive index may be selectively tuned to manipulate light, thermal conductivity may be adjusted to manage heat, and mechanical strength and toughness may be enhanced to provide light-weight structural support. In various applications, optical elements and other components may include polymer thin films that have anisotropic mechanical and/or optical properties.

For conventional light-emitting diode (LED) based AR/VR displays, there is often a need to use polarized light. Such polarized light may be used, for instance, in pancake lenses, waveguide displays, etc. However light directly emitted from LEDs is typically unpolarized and adding common polarizers can decrease their efficiency by 50% or more, resulting in heat absorption and overall increases in power requirements of the headset. It would be preferable for LEDs to have much more efficient polarization with lower losses of unused light.

In various examples described herein, polymer thin films exhibiting optical anisotropy may be incorporated into a variety of systems and devices, including birefringent gratings, reflective polarizers, optical compensators and optical retarders for systems using polarized light such as liquid crystal displays (LCDs). Reflective polarizers may, for example, be used in display-related applications for brightness enhancement within display systems that use polarized light as described herein. In some embodiments, a reflective polarizer may be used to recycle light such that as much as approximately 50% of light (e.g., an unpolarized portion of the light) emitted from an LED (or microLED, OLED, etc.) is reflected back to the LED light source via the reflective polarizer. The reflected light photons may be partially re-absorbed by the LED, which then re-emits more unpolarized photons in response to the light re-absorption. The process may repeat multiple times, increasing LED efficiency and ensuring output light is polarized, with the unpolarized light being continually recycled.

The system efficiency may be limited by re-absorption and re-emission constraints of the LED semiconductor. In the systems disclosed herein, reflective polarizers that are constructed of, for example, highly thin birefringent extruded multilayer polymers. Such reflective polarizer polymer layers may allow for conformal coating, not only on top of the LED surfaces but also on surfaces of micro-lenses in contact with the LEDs. Such micro-lenses may include, for example, arrays of lenses used to collimate and/or change the divergence of LEDs.

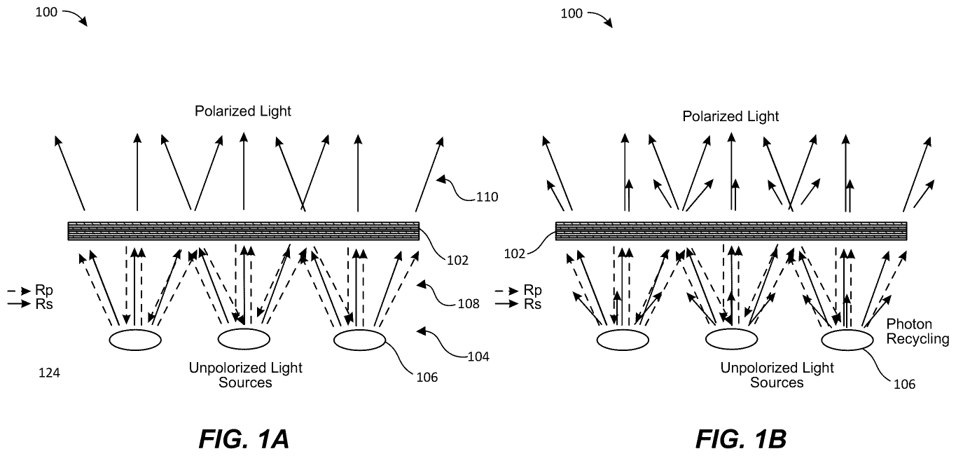

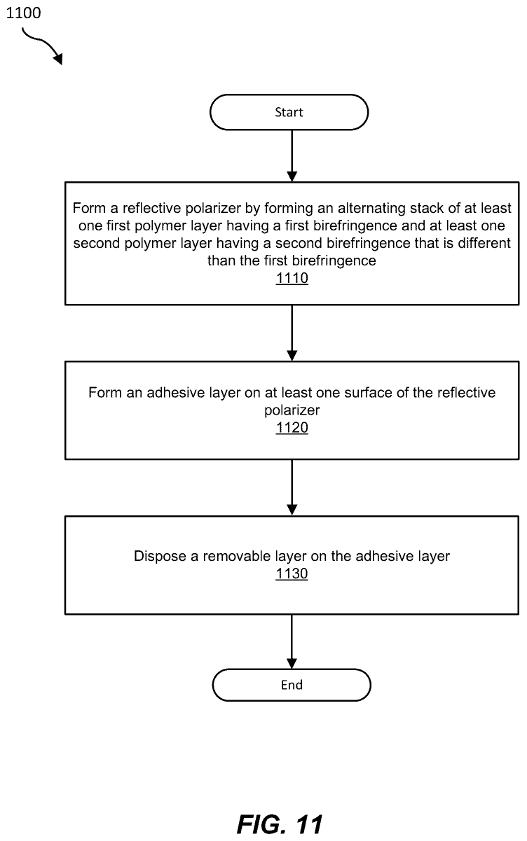

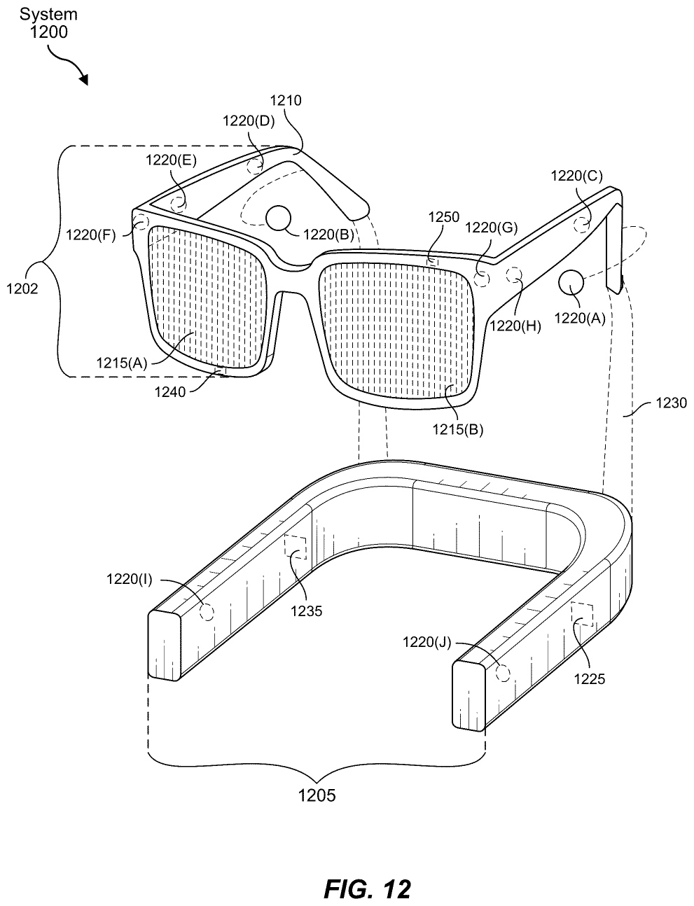

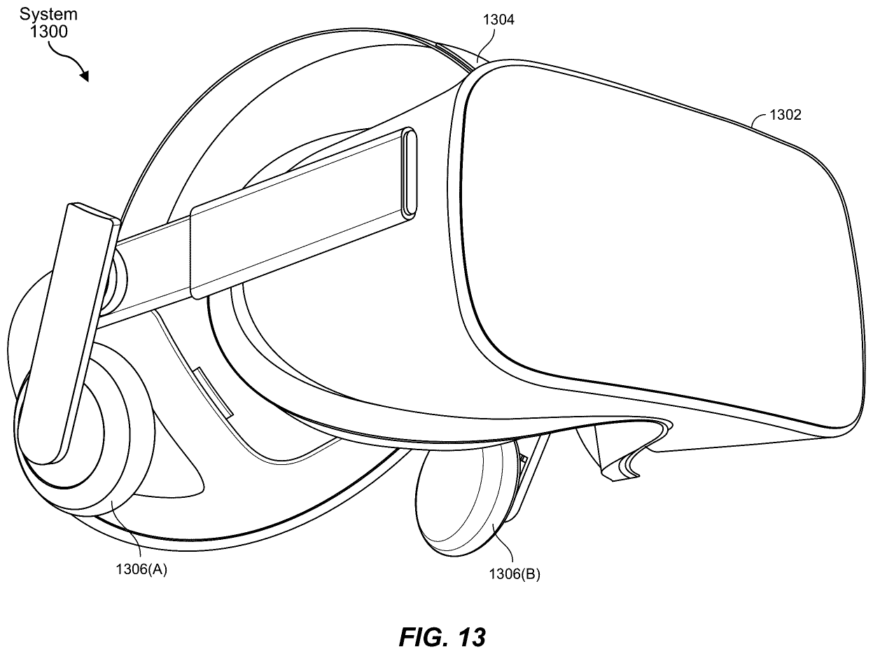

The following will provide, with reference to FIGS. 1A-10C, detailed descriptions of reflective polarizers and light-emitting systems including reflective polarizers to enhance efficiency via photon recycling. The discussion associated with FIGS. 11 and 12 relates to exemplary virtual reality and augmented reality devices that may include one or more multilayer polymer thin films as disclosed herein.

FIGS. 1A-1B show an example system 100 that includes a thin reflective polarizer 102 overlapping a light-emitting array 104 according to some embodiments. As shown in FIG. 1A, a significant amount of emitted light 108 (e.g., approximately 50%) emitted from light sources, such as LEDs 106, of light-emitting array 104 may not pass through thin film reflective polarizer 102, as shown. Instead, a significant portion of the light 108 that is not sufficiently polarized to pass through the reflective polarizer 102 may be reflected back towards LEDs 106 as shown. For example, as further illustrated in FIG. 1B, a substantial portion of emitted light 108 reflected back by reflective polarizer 102 may be re-absorbed by LEDs 106. The re-absorbed light may then be re-emitted again from LEDs 106. At least a portion of the light re-emitted by LEDs 106 may pass through reflective polarizer 102, with a remaining portion being again reflected back to LEDs 106 of light-emitting array 104 to be re-absorbed and re-emitted. Light from LEDs 106 may go through this reflection, re-absorption, re-emission process multiple times, resulting in a higher quantity of polarized light 110 ultimately passing through reflective polarizer 102. Thus, the lighting efficiency of the LED/reflective polarizer assembly of system 100 may be substantially higher than conventional polarized lighting assemblies, with the disclosed assembly providing higher illumination without requiring increased power consumption.

Reflective polarizer films described herein, such as a reflective polarizer film utilized in reflective polarizer 102, may be formed in any suitable manner. In some examples, reflective polarizer films may include one layer or a stack of multiple layers. The layers may include, for example, a polymer layer or multiple overlapping polymer layers. An applied stress may be used to form a preferred alignment of crystals or polymer chains within a polymer thin film and induce a corresponding modification of the optical, thermal, and/or mechanical properties along different directions of the film. As disclosed further herein, during processing in which a polymer thin film is stretched to induce a preferred alignment of crystals/polymer chains and an attendant modification of the refractive index/birefringence, thermal, and mechanical properties, an extrusion technique may be utilized to decrease the propensity for polymer chain entanglement within the extruded thin film.

An extruded polymer thin film or polymer multilayer may be stretched using single or multiple stretching events. Some stretching processes may include two successive stretching events. For example, orthogonal consecutive stretching (OCS) may be used to develop structural fingerprints, such as smaller lamellar thicknesses and higher degrees of polymer chain orientation at draw ratios less than the draw ratios used to achieve similar structural fingerprints via comparative single stretching (SS) or parallel consecutive stretching (PCS) techniques. Orthogonal consecutive stretching may include first stretching a polymer thin film along a first in-plane axis, and then subsequently stretching the polymer thin film along a second in-plane axis that is orthogonal to the first in-plane axis.

Stretching may include a single act of stretching or plural, successive stretching events, such as along different in-plane directions of a polymer thin film. The act of stretching may be velocity limited or strain rate limited. In some embodiments, a polymer thin film may be stretched at a variable or constant velocity. In some embodiments, the polymer thin film may be stretched using a variable strain rate or a constant strain rate (e.g., 0.5/sec, 1/sec, 5/sec, or 10/sec, including ranges between any of the foregoing values). By way of example, the strain rate may decrease throughout an act of stretching and/or amongst different stretching events from an initial strain rate (e.g., 5/sec) to a final strain rate (e.g., 0.5/sec).

The crystalline content within the polymer thin film may increase during the act of stretching. In some embodiments, stretching may alter the orientation of crystals within a polymer thin film without substantially changing the crystalline content.

A polymer thin film may be oriented either uniaxially or biaxially multilayer to form a reflective polarizer. An anisotropic polymer thin film may be formed using a thin film orientation system configured to heat and stretch a polymer thin film in at least one in-plane direction in one or more distinct regions thereof. In some embodiments, a thin film orientation system may be configured to stretch a polymer thin film, i.e., a crystallizable polymer thin film, along only one in-plane direction. For instance, a thin film orientation system may be configured to apply an in-plane stress to a polymer thin film along the x-direction while allowing the thin film to relax along an orthogonal in-plane direction (e.g., along the y-direction). As used herein, the relaxation of a polymer thin film may, in certain examples, accompany the absence of an applied stress along a relaxation direction.

According to some embodiments, within an example orientation system, a polymer thin film may be heated and stretched transversely to a direction of film travel through the system. In such embodiments, a polymer thin film may be held along opposing edges by plural movable clips, or other suitable fasteners or mounting features, that are slidably disposed along a diverging track system such that the polymer thin film is stretched in a transverse direction (TD) as it moves along a machine direction (MD) through heating and deformation zones of the thin film orientation system. In some embodiments, the stretching rate in the transverse direction and the relaxation rate in the machine direction may be independently and locally controlled. In certain embodiments, large scale production may be enabled, for example, using a roll-to-roll manufacturing platform.

In various examples, the extent of relaxation perpendicular to the stretch direction may be approximately equal to the square root of the stretch ratio in the stretch direction. In some embodiments, the extent of relaxation may be substantially constant throughout the stretching process(es). In further embodiments, the extent of relaxation may decrease, with greater relaxation associated with the beginning of a stretch step and lesser relaxation associated with the end of a stretch step.

Following deformation of the polymer thin film, a thermal setting can be applied to the film. The thermal setting temperature can be less than, equal to, or greater than an orientation temperature but above glass transition temperature of the polymers. The thermal setting can be at a constant strain or a variable strain. The thermal setting may be followed by cooling of the polymer thin film. The act of cooling may include allowing the polymer thin film to cool naturally, at a set cooling rate, or by quenching, such as by purging with a low temperature gas, which may thermally stabilize the polymer thin film.

Disclosed polymer thin films may be characterized as optical quality polymer thin films and may form, or be incorporated into, an optical element such as a thin film reflective polarizer, such as reflective polarizer 102 illustrated in FIGS. 1A and 1B. Optical elements may be used in various types of display devices, such as virtual reality and augmented reality glasses and headsets. The efficiency of these and other optical elements may be correspond, at least in part, to the degree of optical clarity, thermal conductivity and/or mechanical response.

As used herein, the terms “polymer thin film” and “polymer layer” may be used interchangeably. Furthermore, reference to a “polymer thin film” or a “polymer layer” may include reference to a “multilayer polymer thin film” unless the context clearly indicates otherwise.

In accordance with various embodiments, an optical element may include a reflective polarizer co-integrated with an anti-reflective coating configured to decrease the reflectance of visible light and IR radiation at least along and/or near the transmissive axis of the reflective polarizer. In various embodiments, the reflective polarizer may include a stack of alternating isotropic and anisotropic polymer layers, and the anti-reflective coating may include one or more polymer layers having a high refractive index and one or more polymer layers having a low refractive index arranged in an alternating ABAB . . . architecture.

In particular embodiments, the reflective polarizer stack, and optionally an anti-reflective coating (ARC), may be co-extruded in a single-step process that decreases manufacturing complexity and, relative to comparative processes, obviates the creation of orange peel defects and the undesired realization of reflectivity ripple along the block axis.

Optical properties of the reflective polarizer or a reflective polarizer and anti-reflective coating (RP-ARC) multilayer stack may be tuned by applying an in-plane stress to the multilayer that induces an alignment of crystallites within the thin films and an attendant modification of refractive index and birefringence. For augmented and/or virtual reality applications, for example, the RP-ARC multilayer may be laminated over a transparent substrate, such as a varifocal lens.

In some embodiments, a sacrificial polymer layer may be co-extruded with the RP-ARC stacks to over-form and protect terminal layers within the multilayer stack. In some examples, the deleterious effects of direct contact between an extrusion die and functional terminal layers of a multilayer extrudate may be overcome by incorporating one or more sacrificial layers that are configured to essentially absorb surface damage caused by the die. Such sacrificial layers may be removed following stretching and orientation of the polymer layers but prior to lamination to a substrate.

Example sacrificial layers may include low surface energy polymers (polymer S), such as polydimethylsiloxane, polypropylene, polyethylene, ethylene-vinyl acetate, polyoxymethylene, polystyrene, polyvinyl alcohol, and fluoropolymers such as polytetrafluoroethylene and polyvinylidene fluoride, as well as combinations and co-polymers thereof. In certain embodiments, a sacrificial layer may be configured as a peelable skin layer, and may have a surface energy of less than approximately 38 dyne/cm.

In at least one embodiment, a first polymer thin film of a multilayer reflective polarizer stack may be optically isotropic, where nₓ=n_{y}=n_{z}, and may include a first polymer composition, i.e., polymer A. In certain embodiments, the first polymer thin film may be characterized by refractive indices nₓ<1.8, n_{y}<1.8, and nₓ−n_{y}<0.1.

The first polymer thin film may include one or more polymers synthesized from at least one acid monomer and at least one alcohol monomer. Example acids include naphthalene dicarboxylic acid, terephthalic acid, isophthalic acid, azelaic acid, norbornene dicarboxylic acid, and other dicarboxylic acids. Suitable acids may be polymerized with glycols including mono-ethylene glycol, diethylene glycol, propylene glycol, butylene glycol, cyclohexane dimethanol, polyethylene glycol, di-hydrogenated organic compounds and the like, as well as combinations and derivatives, including isomers and co-polymers thereof.

A second polymer thin film of the multilayer reflective polarizer stack may include a crystalline or semi-crystalline optically anisotropic polymer, where refractive indices of the layers are related according to nₓ>n_{y}>n_{z} or nₓ>n_{y}=n_{z}, for example, and may include a second polymer composition, i.e., polymer B. In certain embodiments, the second polymer thin film may be characterized by nₓ>1.8, and nₓ−n_{y}>0.1 (e.g., nₓ>1.85, and nₓ−n_{y}>0.2). In particular embodiments, a high contrast ratio may be achieved where the refractive indices for adjacent layers (e.g., first and second thin films) are equal along a common direction, e.g., n_{y}(film 1)=n_{y}(film 2).

The second polymer thin film may include, for example, polyethylene naphthalate, polyethylene terephthalate, polyethylene isophthalate, polybutylene naphthalate, polybutylene terephthalate, polyoxymethylene, as well as aliphatic or semi-aromatic polyamides. In some cases, polymer B may further include one or more oligomers as identified above. The molecular weight of the oligomer may be less than approximately 50% of the molecular weight of the polymer, e.g., less than approximately 30%, less than approximately 10%, less than approximately 5%, or less than approximately 1% of the molecular weight of the polymer. In some cases, polymer B may include a nucleating agent, such as talc, sodium benzoate, or an ionomer.

Although the reflective polarizer stack is described above as having two polymer layers, it will be appreciated that the total number of layers constituting the reflective polarizer stack, as well as any ARC stack formed on top, may be independently chosen to be any integer greater than 2. For instance, the reflective polarizer stack may include 3 or more polymer layers, e.g., 3, 10, 100, 200, 300, 400, 500 or more layers, and an overlapping ARC may include 3 or more polymer layers, e.g., 3, 10, 20, 30, 40, 50 or more layers.

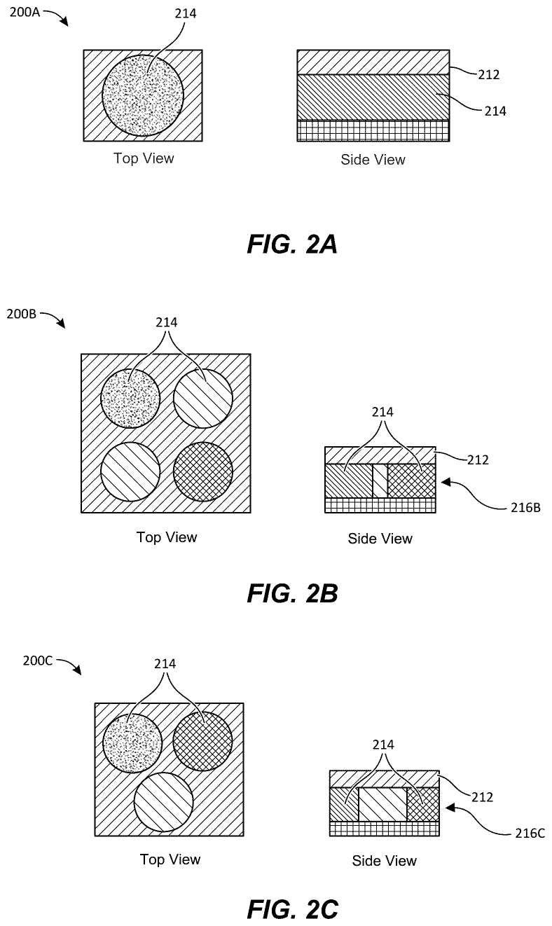

Following orientation of the polymer crystals and removal of the sacrificial layer(s), a multilayer polymer thin film may be laminated over an optical substrate, such as a glass or polymer lens. FIGS. 2A-2C show top and cross-sectional side views of example light-emitting assemblies having reflective polarizers overlapping LEDs according to some embodiments. FIG. 2A shows an assembly 200A that includes reflective polarizer layer 212 overlapping a single LED 214. FIG. 2B shows an assembly 200B that includes a reflective polarizer layer 212 disposed over a multicolor LED structure 216B having multiple LEDs 214, such as a red, green, red, blue (RGRB) LEDs. FIG. 2C shows an assembly 200C that includes a reflective polarizer layer 212 disposed over a multicolor LED structure 216C having multiple LEDs 214, such as a red, green, blue (RGB) LEDs.

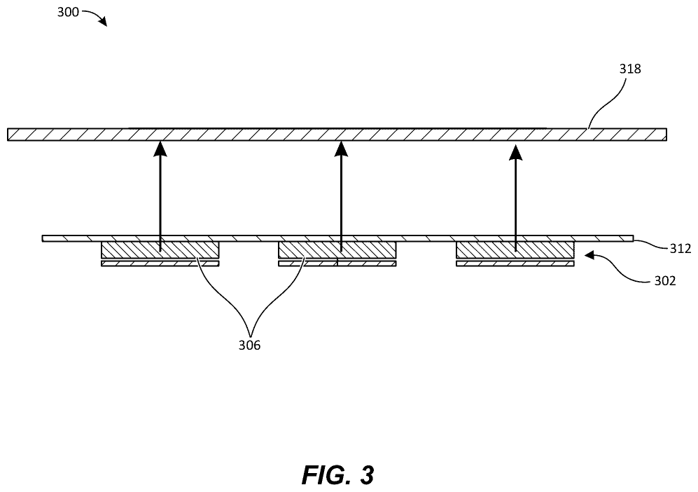

FIG. 3 is a schematic illustration of an example system 300 that includes a thin reflective polarizer 312 overlapping a light-emitting array 302 according to some embodiments. As shown, three exemplary LED light sources 306 may transmit light through reflective polarizer 312 toward, for example, a screen 318. In this example, up to approximately 50% of the light emitted from three exemplary LED light sources 306 may be reflected from thin reflective polarizer 312, re-absorbed by three exemplary LED light sources 306, and then re-emitted by LED light sources 306.

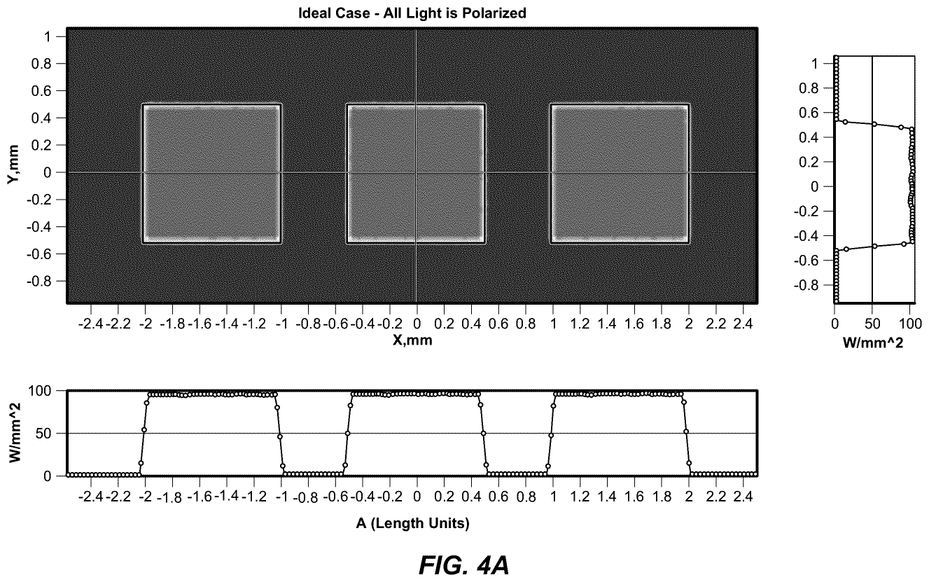

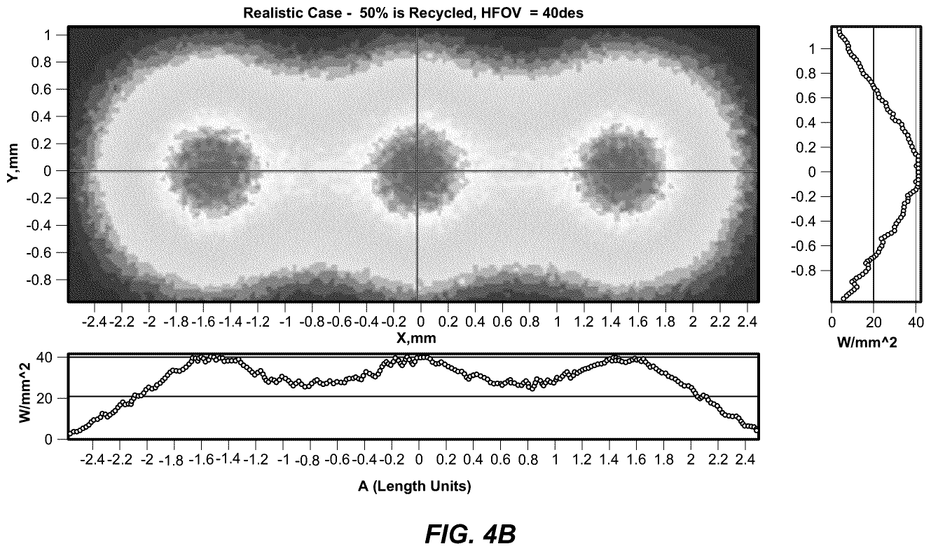

FIGS. 4A and 4B show polarized light emitted from a light-emitting assembly, such as that shown in FIG. 3. FIG. 4A illustrates an example of an idealized polarized light emission scenario in which all light from three LED light sources of an array is polarized. Charts illustrating light intensity in W/mm\hat{ }2 along the length (X) and width (Y) dimensions of the light emission region are shown. As shown, the emitted light regions in this ideal case may have substantially regular boundaries corresponding to the LED shape profiles and contained within a limited viewing region for the array.

FIG. 4B illustrates a pattern for a more realistic polarized light emission scenario, where approximately 50% of the light is recycled by an RP/LED system as described herein (see, e.g., system 300 illustrated in FIG. 3). Accordingly, as illustrated in FIG. 4B, the system may emit light from the array within a wider horizontal field of view of, for example, approximately 40 degrees. Charts illustrating light intensity in W/mm\hat{ }2 along the length (X) and width (Y) dimensions of the light emission region are shown. As shown, the emitted light regions in this more realistic case may be spread to a greater extent than the ideal scenario illustrated in FIG. 4A.

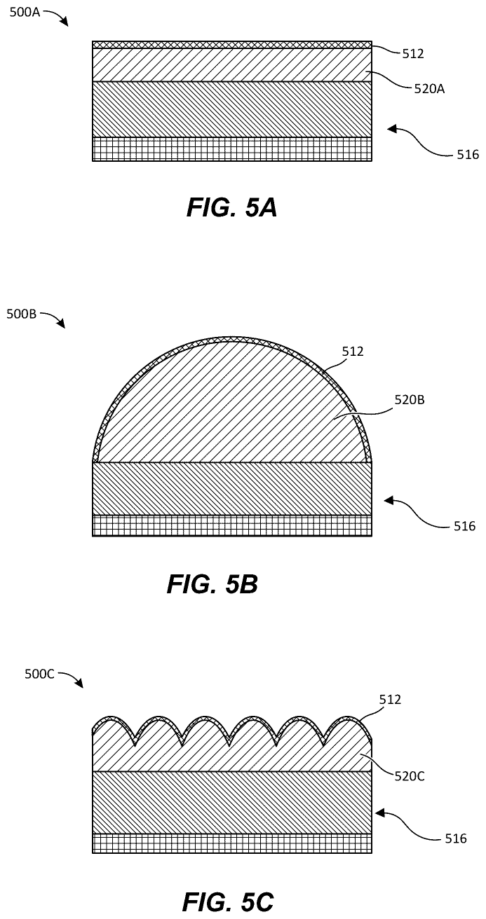

FIG. 5A-5C are cross-sectional views of conformal reflective polarizer films overlapping various LED surfaces according to some embodiments. FIG. 5A shows a light-emitting assembly 500A that includes a reflective polarizer layer 512 overlapping a substantially planar surface, such as a flat surface of layer 520A, covering an LED array 516. FIGS. 5B and 5C illustrate a light-emitting assemblies 500B and 500C that include reflective polarizer layers 512 overlapping nonuniform surfaces. For example, FIG. 5B includes a reflective polarizer layer 512 overlapping a curved surface of a lens 520B disposed over LED array 516. FIG. 5C includes a reflective polarizer layer 512 overlapping a a roughened LED surface (e.g., an undulating surface) of a microlens array 520C disposed over LED array 516.

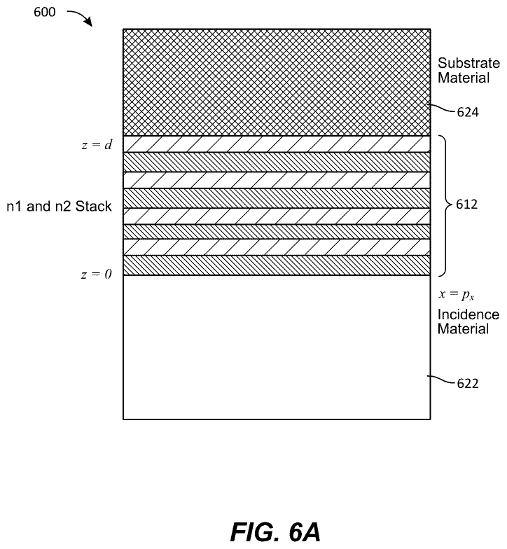

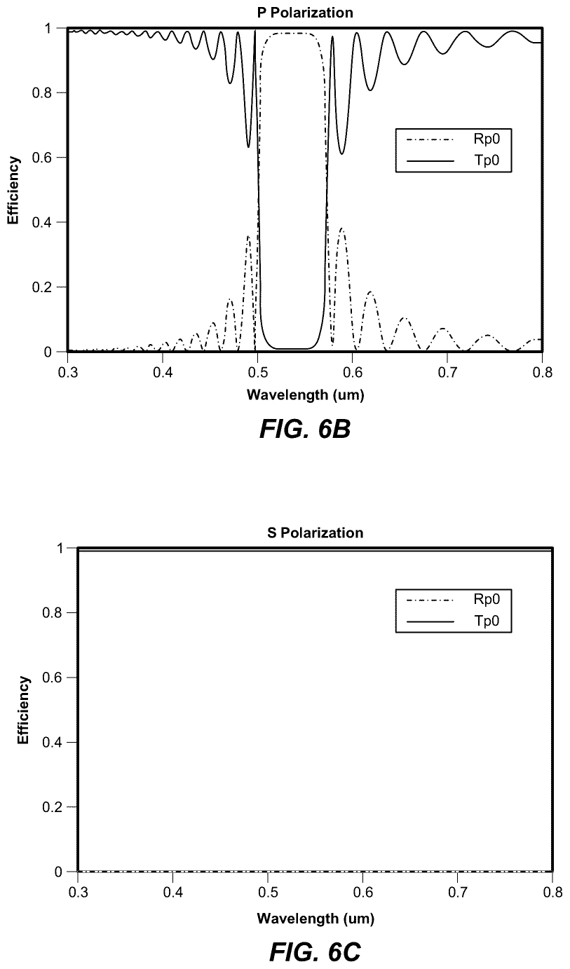

FIG. 6A shows a cross-sectional view of a light-emitting assembly 600 with a multilayer reflective polarizer 612 (n1 and n2 stack). As shown, light-emitting assembly 600 may be disposed between an incidence material 622, which transmits incident light from LEDs, and a substrate material 624. FIG. 6B illustrates spectrums of polarized light emitted from a light-emitting assembly, such as light-emitting assembly 600, which includes a multilayer reflective polarizer. As shown, P-polarized light may efficiently pass through the example reflective polarizer, particularly within selected wavelengths. S-polarized light, on the other hand, may be effectively blocked and reflected over a broad spectrum, as illustrated in FIG. 6C.

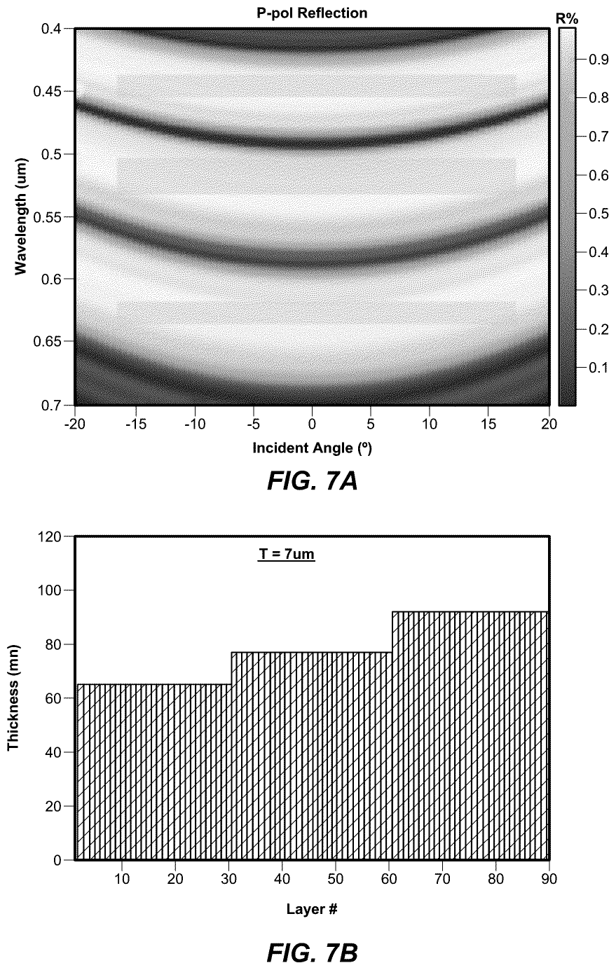

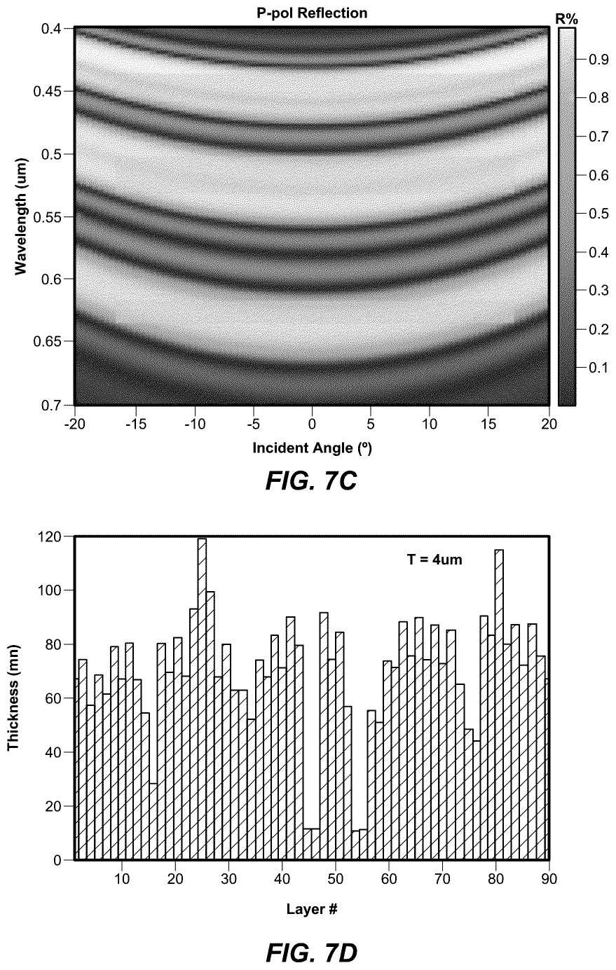

FIGS. 7A-D illustrate example broadband reflective polarizer designs for use with multicolor (e.g., RGB) light-emitting assemblies. FIGS. 7A and 7C illustrate p-polarized light reflection characteristics (wavelength/incidence) for the multilayer reflective polarizers represented, for example, in FIGS. 7B and 7D, respectively. The reflective polarizer represented in FIG. 7B may have a total thickness of approximately 7 μm, with approximately 90 stacked layers having thickness that increase as shown. The reflective polarizer represented in FIG. 7D may have a total thickness of approximately 4 μm, with approximately 60 stacked layers having thickness that vary as shown.

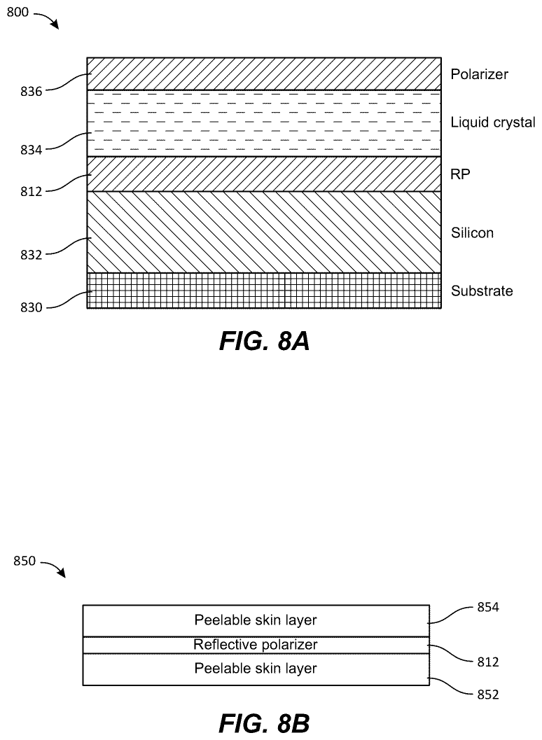

FIG. 8A is a cross-sectional view of an example liquid crystal device 800, such as a liquid crystal on silicon (i.e., LCoS, fLCoS) device, that includes a reflective polarizer 812. As shown, reflective polarizer 812 may be disposed overlapping, for example, a reflective silicon layer 832 disposed on a substrate 830. Reflective polarizer 812 may reflect light from substrate 830 that is not polarized in a selected orientation. The light reflected from reflective polarizer 812 may be reflected again by reflective silicon layer 832. Only light that is ultimately polarized in a selected orientation may pass through reflective polarizer reflective polarizer 812 to liquid crystal layer 834. Thus, the efficiency of properly polarized light passing through reflective polarizer 812 and liquid crystal 834 layer may be enhanced. The polarized light passing through reflective polarizer 812 and liquid crystal layer 834 may selectively polarized to readily pass through polarizer 836.

FIG. 8B shows a cross-sectional view of an assembly 850 that includes a reflective polarizer 812 that is disposed between two removable layers 852 and 854 (i.e., peelable skin layers). In some examples, the ultrathin reflective polarizer 812 may include two removable layers 852 and 854 on both sides of reflective polarizer 812 to protect reflective polarizer 812 during a film forming process and downstream lamination process. Examples of removable layers 852 and 854 may include low surface energy polymers such as polydimethylsiloxane, polypropylene, polyethylene, ethylene-vinyl acetate, polyoxymethylene, polystyrene, polyvinyl alcohol, and fluoropolymers such as polytetrafluoroethylene and polyvinylidene fluoride, as well as combinations and co-polymers thereof. In certain embodiments, a sacrificial layer may be configured as a removable layer and may have a surface energy of less than approximately 38 dyne/cm. In other cases, a release coating, such as a an adhesive layer, may be be added in between each of removable layers 852 and 854 and reflective polarizer 812.

In at least one example, removable layers 852 and 854 can be co-extruded with reflective polarizer 812. Additionally or alternatively, removable layers 852 and 854 can be solvent coated on reflective polarizer 812 after reflective polarizer 812 is formed. The solvent coating can be conducted as blade coating, spray coating or dip coating. In other cases, removable layers 852 and 854 can be added by vapor deposition after reflective polarizer 812 is formed.

In various embodiments, to avoid pixel crosstalk and/or interference, patterns can be made on the top of the reflective polarizer. Such patterns can be designed based on pixel distance and light source position. For example, a pattern can simply be a repeated rectangular or circular shape(s). The pattern can be imprinted to the film through, for example, a patterned chill roll right after extrusion. The pattern can be imprinted after a reflective polarizer is formed by stamping at an elevated temperature. The pattern can also be formed by laser cut patterning or blade cut patterning. Any other suitable patterning technique may be additionally or alternatively used.

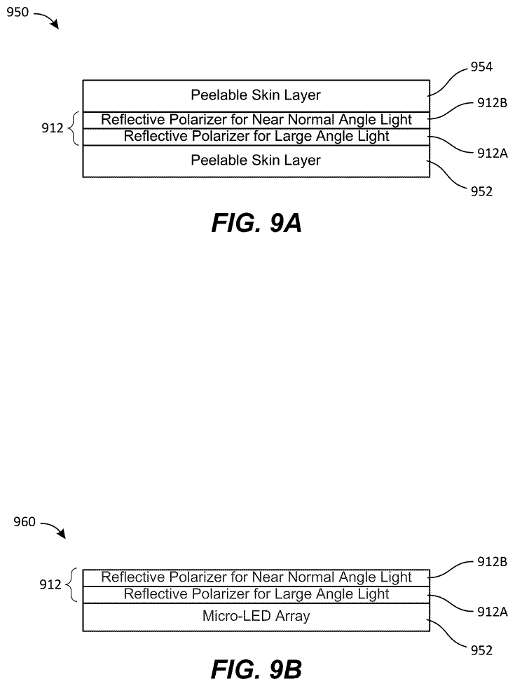

FIG. 9A shows a cross-sectional view of an assembly 950 that includes a reflective polarizer stack 912 having at least two reflective polarizer layers or regions disposed between a pair of removable layers 952 and 954 according to some embodiments. In some cases, reflective polarizer stack 912 may have two regions (e.g., two regions in two or more separate reflective polarizer layers as shown). One region may, for example, be a large angle reflective region 912A that reflects large angle light from a light source. The other region may, for example, be a normal angle reflective region 912B that reflects normal and/or near normal angle light from the light source. In various examples, large angle reflective region 912A reflecting the large angle light may be closer to the light source, while normal angle reflective region 912B reflecting the near normal angle light may be further away from the light source.

FIG. 9B shows a cross-sectional view of an assembly 960 that includes reflective polarizer stack 912 of FIG. 9A overlapping a micro-LED array 962 according to some embodiments. As shown, removable layer 952 and/or 954 may be removed during or prior to affixing reflective polarizer stack 912 to micro-LED array 962. In some cases, reflective polarizer stack 912 may be conformable to light sources, including light sources with uneven surfaces.

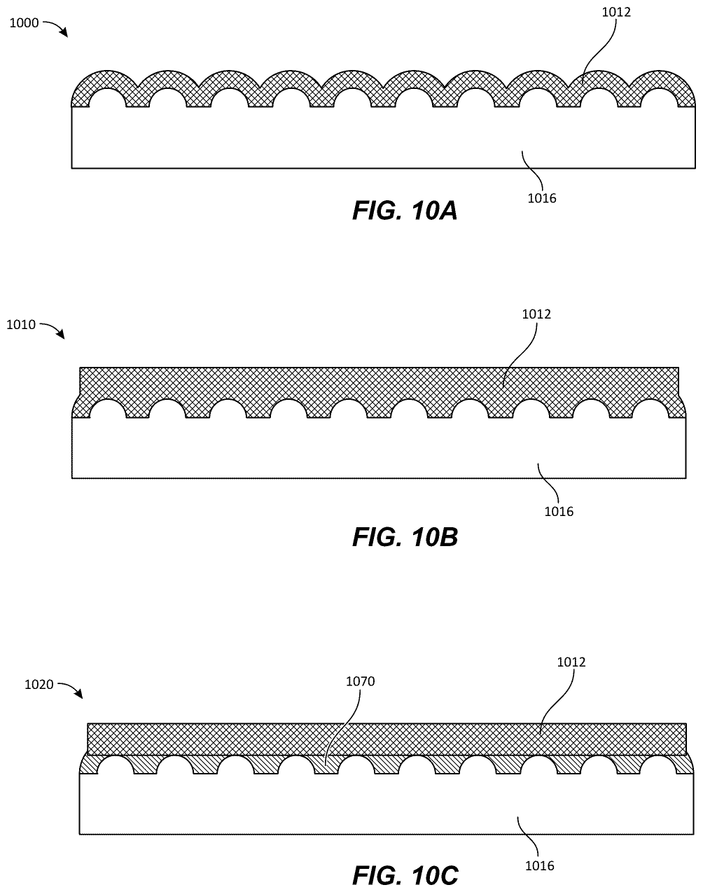

In some embodiments, as shown in micro-LED array assemblies 1000 and 1010 of FIGS. 10A and 10B, a reflective polarizer 1012 may be conformable to uneven surfaces of micro-LED arrays 1016.

In at least one embodiment, as shown in FIG. 10C, reflective polarizer 1012 may not conform to an uneven surface of micro-LED array 1016. In this example, a fill material, such as resin 1070, may be used to fill spaces in between uneven surface portions of micro-LED array 1016 and reflective polarizer 1012 (e.g., spaces between micro-lenses or other surface features), as shown

An integrated polarization recycling system may include an LED-based light source and a thin polymer reflective polarizer to improve the polarized light emission efficiency. Light sources may include but are not limited to LED, micro-LED, OLED, microOLED, LCoS, and fLCoS. The thin polymer may be made of polymer birefringent multilayer structures. The multilayer structures may include alternating first and second polymer layers, the first polymer layers each having a polymer thin film having in-plane refractive indices n1x and n1y, and the second polymer layers each having a polymer thin film having in-plane refractive indices n2x and n2y, where n1x=n1y and n2x<n2y or and n2y<n2x. Where n1x<1.8, n1y<1.8, |n1x-n1y|<0.1, n2y>1.5, and |n2x-n2y|>0.05 (in some cases, |n2x-n2y|>0.1). The total thickness of reflective polarizer may be <0.5 h, where h is the height of the semiconductor component of LED. The reflective polarizer spectral bandwidth may be at least 1.1 times larger than the spectral bandwidth of the LED but not larger than twice such bandwidth and the center wavelength of LED emission matches the center wavelength of the reflective polarizer design. The reflective polarizer may reflect above 90% s- or p- polarized light while transmitting at least 85% of the other of p- or s- polarized light. The LED's external surfaces may be covered with the reflective polarizer.

An integrated polarization recycling system may include a group LED based light source and a thin polymer reflective polarizer to improve the polarized light emission efficiency. The light sources may include but are not limited to LED, micro-LED, OLED, microOLED, LCoS, and fLCoS. The LED group can include 2 to 6 LEDs. Each LED may emit a red, green, or blue spectrum. The reflective polarizer spectral bandwidth may be broadband and cover at least the sum of the LED group within the visible spectrum (400 to 720 nm). The thin polymer reflective polarizer may be made of polymer birefringent multilayer structures. The multilayer structures may include alternating first and second polymer layers, the first polymer layers each including a polymer thin film having in-plane refractive indices n1x and n1y, and the second polymer layers each including a polymer thin film having in-plane refractive indices n2x and n2y. Where n1x=n1y and n2x<n2y or and n2y<n2x. Where n1x<1.8, n1y<1.8, |n1x-n1y|<0.1, n2y>1.5, and |n2x-n2y|>0.3. A total thickness of the reflective polarizer may be <0.5 h, where h is the height of the semiconductor component of LED. The reflective polarizer spectral bandwidth may be at least 1 times larger than the spectral bandwidths of the LEDs but not larger than twice such bandwidths. The reflective polarizer may reflect above 90% s- or p- polarized light while transmitting at least 85% of the other of p- or s- polarized light. The LED's or group thereof external surfaces may be covered with the reflective polarizer.

An integrated polarization recycling system may include an LED-based light source, thin polymer reflective polarizer to improve the polarized light emission efficiency, and an optical component attached to the LED to control light direction and divergence of the LED. Light sources may include, but are not limited to, LED, micro-LED, OLED, microOLED, LCoS, and fLCoS. The thin polymer reflective polarizer may be made of polymer birefringent multilayer structures. The multilayer structures may include alternating first and second polymer layers, the first polymer layers each including a polymer thin film having in-plane refractive indices n1x and n1y, and the second polymer layers each including a polymer thin film having in-plane refractive indices n2x and n2y. Where n1x=n1y and n2x<n2y or and n2y<n2x. Where n1x<1.8, n1y<1.8, |n1x-n1y|<0.1, n2y>1.5, and |n2x-n2y|>0.05. A total thickness of the reflective polarizer may be <0.5 h, where h is the height of the semiconductor component of LED. The reflective polarizer spectral bandwidth may be at least 1.1 times larger than the spectral bandwidth of the LED but not larger than three times such bandwidth and the center wavelength of LED emission matches the center wavelength of the reflective polarizer design. The reflective polarizer may reflect above 90% s- or p- polarized light while transmitting at least 85% of the other of p- or s-polarized light. The optical component can be a micro lens, metasurface, diffractive component or surface roughness to reduce total internal reflection (TIR). The micro lens can be spherical, aspherical, or cylindrical, converging (focal length between 10 microns to 500 microns) or diverging light from (0 deg up to 60 deg divergence). The optical component may be coated with the reflective polarizer film.

An ultrathin reflective polarizer may include at least one peelable skin layer and a multilayer reflective polarizer that is less than approximately 15 um. The multilayer reflective polarizer may be less than 10 um. The skin layer may include a moiety having a surface energy of less than approximately 38 dyne/cm. A releasing coating can be added in between the peelable skin layer and the reflective polarizer. The skin layer may include a moiety selected from the group consisting of polyethylene, polypropylene, and a fluorinated polymer. Patch patterns may be included on the reflective polarizer surface to avoid pixel crosstalk.

A reflective polarizer may reflect high-angle light closer to the emitting surface and may reflects light with small angles further away from the emitting surface. The reflective polarizer may have a first and a second major surface and a thickness, where the reflective polarizer has a first and a second reflective polarizer region, with the first reflective polarizer region being adjacent to the first major surface and the second reflective polarizer region being adjacent to the first reflective polarizer region. The first reflective polarizer region may preferentially reflect at least one of red, green, and blue light at an incident angle in air of about 45 degrees from normal from the first major surface, and the second reflective polarizer region may preferentially reflect at least of one of red, green, and blue light with an incidence angle of between about 0 and about 20 degrees. The thickness may be between the first major surface and the closest point of the reflective polarizer region may be less than approximately 10 microns (e.g., approximately 5, approximately 2 microns). The spacing between the first and second reflective polarizer regions may be less than approximately 10 microns (e.g., approximately 5, approximately 2 microns). The reflective polarizer may include a multilayer optical film made of at least one birefringent polymer layer, or made of a cholesteric reflective polarizer, or a combination thereof.

A reflective polarizer with low thickness may have a first and a second major surface, where at least the first major surface is within approximately 10, 5, 2, or 1 microns of the reflective polarizer. A method of making such a reflective polarizer may include forming the reflective polarizer of an alternating stack of a first polymer that forms high birefringence and a second polymer that forms a relatively low birefringence, where there is a releasable layer between at least the first major surface and the reflective polarizer stack. The releasable layer may be located between the reflective polarizer and a skin layer forming the first major surface. The releasable layer may include a fluorinated polymer, including at least one of PVDF, PFE, copolymers, polyethylene, polypropylene, cyclic olefin polymers and copolymers, and mixtures thereof. The releasable layer may form the skin layer.

FIG. 11 is a flow diagram illustrating a method 1100 of fabricating a reflective polarizer assembly according to at least one embodiment of the present disclosure. As illustrated in FIG. 11, at operation 1110, a reflective polarizer may be formed by forming an alternating stack of at least one first polymer layer having a first birefringence and at least one second polymer layer having a second birefringence that is different than the first birefringence.

At operation 1120, an adhesive layer may be formed on at least one surface of the reflective polarizer.

At operation 1130, a removable layer may be disposed on the adhesive layer.

### EXAMPLE EMBODIMENTS

Example 1: A lighting assembly including a light source and a reflective polarizer overlapping the light source, wherein a portion of light that is incident on the reflective polarizer does not pass through the reflective polarizer and is reflected back to the light source

Example 2: The display system of Example 1, further including an optical element disposed between the light source and the reflective polarizer, wherein the optical element is coupled to the light source and the optical element is covered by the reflective polarizer.

Example 3: The display system of any of Examples 1 and 2, wherein the light reflected back to the light source is re-absorbed by the light source and, in response to re-absorbing the light, the light source re-emits light toward the reflective polarizer.

Example 4: The display system of any of Examples 1-3, wherein the light source includes at least one of a light emitting diode (LED), a micro-LED, an organic light emitting diode (OLED), a micro-OLED, a liquid crystal on silicon (LCoS), or an fLCoS light source.

Example 5: The display system of any of Examples 1-4, wherein the reflective polarizer includes a thin polymer reflective polarizer.

Example 6: The display system of Example 5, wherein the thin polymer reflective polarizer includes a polymer birefringent multilayer structure.

Example 7: The display system of Example 6, wherein 1) the birefringent multilayer structure includes alternating first and second layers, 2) the first layers each include an isotropic polymer thin film having in-plane refractive indices nₓ (1) and n_{y}(1) and the second layers each include an anisotropic polymer thin film having in-plane refractive indices nₓ (2) and n_{y}(2), 3) n1x=n1y and n2x<n2y or n2y<n2x, and 4) n1x<1.8, n1y<1.8, |n1x-n1y|<0.1, n2y>1.5, and |n2x-n2y|>0.05.

Example 8: The display system of Example 7, wherein |n2x-n2y|>0.1.

Example 9: The display system of Example 6, wherein the birefringent multilayer structure has an average reflection of less than approximately 1% over a range of 400 nm to 700 nm along a pass direction, and an average reflection of at least approximately 90% over a range of 400 nm to 700 nm along a block direction.

Example 10: The display system of any of Examples 1-9, wherein the total thickness of the reflective polarizer is <0.5 h, where h is the height of the semiconductor component of LED.

Example 11: The display system of any of Examples 1-10, wherein the reflective polarizer spectral bandwidth is at least 1.1 times larger than the spectral bandwidth of the LED but not larger than twice such bandwidth and the center wavelength of LED emission matches the center wavelength of the reflective polarizer.

Example 12: The display system of any of Examples 1-11, wherein the reflective polarizer reflects above 90% of one of s- or p- polarized light while transmitting at least 85% of the other of s- or p- polarized light.

Example 13: The display system of any of Examples 1-12, further including a sacrificial layer disposed directly over the reflective polarizer, wherein the sacrificial layer includes a moiety having a surface energy of less than approximately 38 dyne/cm.

Example 14: The display system of any of Examples 1-13, wherein the light source includes a group of 2 to 6 LEDs and each LED emits at least one of a red, green, or blue spectrum light.

Example 15: The display system of Example 14, wherein the reflective polarizer spectral bandwidth is broadband and covers at least the sum of the LED group within a visible spectrum of about 400 to 720 nm.

Example 16: The display system of any of Examples 14 and 15, wherein the reflective polarizer spectral bandwidth is at least 1 times larger than the spectral bandwidth of the LEDs but not larger than twice such bandwidth.

Example 17: The color conversion unit of any one of Examples 1-16, further including at least one removable layer overlapping a surface of the reflective polarizer.

Example 18: A reflective polarizer including a first major surface, a second major surface, a first reflective polarizer region, and a second reflective polarizer region, wherein 1) the first reflective polarizer region is adjacent to the first major surface, 2) the second reflective polarizer region is adjacent to the first reflective polarizer region, 3) the first reflective polarizer region preferentially reflects at least one of red, green, or blue light at an incident angle in air of about 30-60 degrees from normal from the first major surface, and 4) the second reflective polarizer region reflects at least of one of red, green, or blue light with an incidence angle in air of between about 0 and about 20 degrees from normal.

Example 19: A method including forming a reflective polarizer by forming an alternating stack of at least one first polymer layer having a first birefringence and at least one second polymer layer having a second birefringence that is different than the first birefringence, and forming an adhesive layer on at least one surface of the reflective polarizer.

Example 20: The method of Example 19, further including disposing a removable layer on the adhesive layer.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1200 in FIG. 12) or that visually immerses a user in an artificial reality (such as, e.g., virtual-reality system 1300 in FIG. 13). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Augmented-reality system 1200 may include an eyewear device 1202 with a frame 1210 configured to hold a left display device 1215(A) and a right display device 1215(B) in front of a user's eyes. Display devices 1215(A) and 1215(B) may act together or independently to present an image or series of images to a user. While augmented-reality system 1200 includes two displays, embodiments of this disclosure may be implemented in augmented-reality systems with a single NED or more than two NEDs.

In some embodiments, augmented-reality system 1200 may include one or more sensors, such as sensor 1240. Sensor 1240 may generate measurement signals in response to motion of augmented-reality system 1200 and may be located on substantially any portion of frame 1210. Sensor 1240 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1200 may or may not include sensor 1240 or may include more than one sensor. In embodiments in which sensor 1240 includes an IMU, the IMU may generate calibration data based on measurement signals from sensor 1240. Examples of sensor 1240 may include, without limitation, accelerometers, gyroscopes, magnetometers, other suitable types of sensors that detect motion, sensors used for error correction of the IMU, or some combination thereof.

In some examples, augmented-reality system 1200 may also include a microphone array with a plurality of acoustic transducers 1220(A)-1220(J), referred to collectively as acoustic transducers 1220. Acoustic transducers 1220 may represent transducers that detect air pressure variations induced by sound waves. Each acoustic transducer 1220 may be configured to detect sound and convert the detected sound into an electronic format (e.g., an analog or digital format). The microphone array in FIG. 12 may include, for example, ten acoustic transducers: 1220(A) and 1220(B), which may be designed to be placed inside a corresponding ear of the user, acoustic transducers 1220(C), 1220(D), 1220(E), 1220(F), 1220(G), and 1220(H), which may be positioned at various locations on frame 1210, and/or acoustic transducers 1220(1) and 1220(J), which may be positioned on a corresponding neckband 1205.

In some embodiments, one or more of acoustic transducers 1220(A)-(J) may be used as output transducers (e.g., speakers). For example, acoustic transducers 1220(A) and/or 1220(B) may be earbuds or any other suitable type of headphone or speaker.

The configuration of acoustic transducers 1220 of the microphone array may vary. While augmented-reality system 1200 is shown in FIG. 12 as having ten acoustic transducers 1220, the number of acoustic transducers 1220 may be greater or less than ten. In some embodiments, using higher numbers of acoustic transducers 1220 may increase the amount of audio information collected and/or the sensitivity and accuracy of the audio information. In contrast, using a lower number of acoustic transducers 1220 may decrease the computing power required by an associated controller 1250 to process the collected audio information. In addition, the position of each acoustic transducer 1220 of the microphone array may vary. For example, the position of an acoustic transducer 1220 may include a defined position on the user, a defined coordinate on frame 1210, an orientation associated with each acoustic transducer 1220, or some combination thereof.

Acoustic transducers 1220(A) and 1220(B) may be positioned on different parts of the user's ear, such as behind the pinna, behind the tragus, and/or within the auricle or fossa. Or, there may be additional acoustic transducers 1220 on or surrounding the ear in addition to acoustic transducers 1220 inside the ear canal. Having an acoustic transducer 1220 positioned next to an ear canal of a user may enable the microphone array to collect information on how sounds arrive at the ear canal. By positioning at least two of acoustic transducers 1220 on either side of a user's head (e.g., as binaural microphones), augmented-reality device 1200 may simulate binaural hearing and capture a 3D stereo sound field around about a user's head. In some embodiments, acoustic transducers 1220(A) and 1220(B) may be connected to augmented-reality system 1200 via a wired connection 1230, and in other embodiments acoustic transducers 1220(A) and 1220(B) may be connected to augmented-reality system 1200 via a wireless connection (e.g., a BLUETOOTH connection). In still other embodiments, acoustic transducers 1220(A) and 1220(B) may not be used at all in conjunction with augmented-reality system 1200.

Acoustic transducers 1220 on frame 1210 may be positioned in a variety of different ways, including along the length of the temples, across the bridge, above or below display devices 1215(A) and 1215(B), or some combination thereof. Acoustic transducers 1220 may also be oriented such that the microphone array is able to detect sounds in a wide range of directions surrounding the user wearing the augmented-reality system 1200. In some embodiments, an optimization process may be performed during manufacturing of augmented-reality system 1200 to determine relative positioning of each acoustic transducer 1220 in the microphone array.

In some examples, augmented-reality system 1200 may include or be connected to an external device (e.g., a paired device), such as neckband 1205. Neckband 1205 generally represents any type or form of paired device. Thus, the following discussion of neckband 1205 may also apply to various other paired devices, such as charging cases, smart watches, smart phones, wrist bands, other wearable devices, hand-held controllers, tablet computers, laptop computers, other external compute devices, etc.

As shown, neckband 1205 may be coupled to eyewear device 1202 via one or more connectors. The connectors may be wired or wireless and may include electrical and/or non-electrical (e.g., structural) components. In some cases, eyewear device 1202 and neckband 1205 may operate independently without any wired or wireless connection between them. While FIG. 12 illustrates the components of eyewear device 1202 and neckband 1205 in example locations on eyewear device 1202 and neckband 1205, the components may be located elsewhere and/or distributed differently on eyewear device 1202 and/or neckband 1205. In some embodiments, the components of eyewear device 1202 and neckband 1205 may be located on one or more additional peripheral devices paired with eyewear device 1202, neckband 1205, or some combination thereof.

Pairing external devices, such as neckband 1205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1200 may be provided by a paired device or shared between a paired device and an eyewear device, thus reducing the weight, heat profile, and form factor of the eyewear device overall while still retaining desired functionality. For example, neckband 1205 may allow components that would otherwise be included on an eyewear device to be included in neckband 1205 since users may tolerate a heavier weight load on their shoulders than they would tolerate on their heads. Neckband 1205 may also have a larger surface area over which to diffuse and disperse heat to the ambient environment. Thus, neckband 1205 may allow for greater battery and computation capacity than might otherwise have been possible on a stand-alone eyewear device. Since weight carried in neckband 1205 may be less invasive to a user than weight carried in eyewear device 1202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1205 may be communicatively coupled with eyewear device 1202 and/or to other devices. These other devices may provide certain functions (e.g., tracking, localizing, depth mapping, processing, storage, etc.) to augmented-reality system 1200. In the embodiment of FIG. 12, neckband 1205 may include two acoustic transducers (e.g., 1220(1) and 1220(J)) that are part of the microphone array (or potentially form their own microphone subarray). Neckband 1205 may also include a controller 1225 and a power source 1235.

Acoustic transducers 1220(1) and 1220(J) of neckband 1205 may be configured to detect sound and convert the detected sound into an electronic format (analog or digital). In the embodiment of FIG. 12, acoustic transducers 1220(1) and 1220(J) may be positioned on neckband 1205, thereby increasing the distance between the neckband acoustic transducers 1220(1) and 1220(J) and other acoustic transducers 1220 positioned on eyewear device 1202. In some cases, increasing the distance between acoustic transducers 1220 of the microphone array may improve the accuracy of beamforming performed via the microphone array. For example, if a sound is detected by acoustic transducers 1220(C) and 1220(D) and the distance between acoustic transducers 1220(C) and 1220(D) is greater than, e.g., the distance between acoustic transducers 1220(D) and 1220(E), the determined source location of the detected sound may be more accurate than if the sound had been detected by acoustic transducers 1220(D) and 1220(E).

Controller 1225 of neckband 1205 may process information generated by the sensors on neckband 1205 and/or augmented-reality system 1200. For example, controller 1225 may process information from the microphone array that describes sounds detected by the microphone array. For each detected sound, controller 1225 may perform a direction-of-arrival (DOA) estimation to estimate a direction from which the detected sound arrived at the microphone array. As the microphone array detects sounds, controller 1225 may populate an audio data set with the information. In embodiments in which augmented-reality system 1200 includes an inertial measurement unit, controller 1225 may compute all inertial and spatial calculations from the IMU located on eyewear device 1202. A connector may convey information between augmented-reality system 1200 and neckband 1205 and between augmented-reality system 1200 and controller 1225. The information may be in the form of optical data, electrical data, wireless data, or any other transmittable data form. Moving the processing of information generated by augmented-reality system 1200 to neckband 1205 may reduce weight and heat in eyewear device 1202, making it more comfortable to the user.

Power source 1235 in neckband 1205 may provide power to eyewear device 1202 and/or to neckband 1205. Power source 1235 may include, without limitation, lithium ion batteries, lithium-polymer batteries, primary lithium batteries, alkaline batteries, or any other form of power storage. In some cases, power source 1235 may be a wired power source. Including power source 1235 on neckband 1205 instead of on eyewear device 1202 may help better distribute the weight and heat generated by power source 1235.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1300 in FIG. 13, that mostly or completely covers a user's field of view. Virtual-reality system 1300 may include a front rigid body 1302 and a band 1304 shaped to fit around a user's head. Virtual-reality system 1300 may also include output audio transducers 1306(A) and 1306(B). Furthermore, while not shown in FIG. 13, front rigid body 1302 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1200 and/or virtual-reality system 1300 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1200 and/or virtual-reality system 1300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1200 and/or virtual-reality system 1300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a polymer thin film that comprises or includes polyethylene naphthalate include embodiments where a polymer thin film consists essentially of polyethylene naphthalate and embodiments where a polymer thin film consists of polyethylene naphthalate.

What is claimed is:

1. A lighting assembly comprising:
a light source; and
a reflective polarizer overlapping the light source, wherein a portion of light that is incident on the reflective polarizer does not pass through the reflective polarizer and is reflected back to the light source.

2. The lighting assembly of claim 1, further comprising an optical element disposed between the light source and the reflective polarizer, wherein:
the optical element is coupled to the light source; and
the optical element is covered by the reflective polarizer.

3. The lighting assembly of claim 1, wherein:
the light reflected back to the light source is re-absorbed by the light source; and
in response to re-absorbing the light, the light source re-emits light toward the reflective polarizer.

4. The lighting assembly of claim 1, wherein the light source comprises at least one of a light emitting diode (LED), a micro-LED, an organic light emitting diode (OLED), a micro-OLED, a liquid crystal on silicon (LCoS), or an fLCoS light source.

5. The lighting assembly of claim 1, wherein the reflective polarizer comprises a thin polymer reflective polarizer.

6. The lighting assembly of claim 5, wherein the thin polymer reflective polarizer comprises a polymer birefringent multilayer structure.

7. The lighting assembly of claim 6, wherein:
the birefringent multilayer structure comprises alternating first and second layers;
the first layers each comprise an isotropic polymer thin film having in-plane refractive indices nₓ (1) and n_{y} (1) and the second layers each comprise an anisotropic polymer thin film having in-plane refractive indices nₓ (2) and n_{y} (2);
n1x=n1y and n2x<n2y or n2y<n2x; and
n1x<1.8, n1y<1.8, |n1x-n1y|<0.1, n2y>1.5, and |n2x-n2y|>0.05.

8. The lighting assembly of claim 7, wherein |n2x-n2y|>0.1.

9. The lighting assembly of claim 6, wherein the birefringent multilayer structure has an average reflection of less than approximately 1% over a range of 400 nm to 700 nm along a pass direction, and an average reflection of at least approximately 90% over a range of 400 nm to 700 nm along a block direction.

10. The lighting assembly of claim 1, wherein the total thickness of the reflective polarizer is <0.5 h, where h is the height of the semiconductor component of LED.

11. The lighting assembly of claim 1, wherein the reflective polarizer spectral bandwidth is at least 1.1 times larger than the spectral bandwidth of the LED but not larger than twice such bandwidth and the center wavelength of LED emission matches the center wavelength of the reflective polarizer.

12. The lighting assembly of claim 1, wherein the reflective polarizer reflects above 90% of one of s- or p- polarized light while transmitting at least 85% of the other of s- or p-polarized light.

13. The lighting assembly of claim 1, further comprising a sacrificial layer disposed directly over the reflective polarizer, wherein the sacrificial layer comprises a moiety having a surface energy of less than approximately 38 dyne/cm.

14. The lighting assembly of claim 1, wherein:
the light source includes a group of 2 to 6 LEDs; and
each LED emits at least one of a red, green, or blue spectrum light.

15. The lighting assembly of claim 14, wherein the reflective polarizer spectral bandwidth is broadband and covers at least the sum of the LED group within a visible spectrum of about 400 to 720 nm.

16. The lighting assembly of claim 14, wherein the reflective polarizer spectral bandwidth is at least 1 times larger than the spectral bandwidth of the LEDs but not larger than twice such bandwidth.

17. The lighting assembly of claim 1, further comprising at least one removable layer overlapping a surface of the reflective polarizer.

18. A reflective polarizer comprising:
a first major surface;
a second major surface;
a first reflective polarizer region; and
a second reflective polarizer region,
wherein:
the first reflective polarizer region is adjacent to the first major surface;
the second reflective polarizer region is adjacent to the first reflective polarizer region;
the first reflective polarizer region preferentially reflects at least one of red, green, or blue light at an incident angle in air of about 30-60 degrees from normal from the first major surface; and
the second reflective polarizer region reflects at least of one of red, green, or blue light with an incidence angle in air of between about 0 and about 20 degrees from normal.

19. A method comprising:
forming a reflective polarizer by forming an alternating stack of at least one first polymer layer having a first birefringence and at least one second polymer layer having a second birefringence that is different than the first birefringence; and
forming an adhesive layer on at least one surface of the reflective polarizer.

20. The method of claim 19, further comprising disposing a removable layer on the adhesive layer.
